(19) United States
(12) Patent Application Publication
(10) Pub. No.: US 2016/0234199 A1
(43) Pub. Date: Aug. 11, 2016

(54) METHOD AND APPARATUS FOR PROVIDING AUTHENTICATION BASED ON AGGREGATED ATTRIBUTE IN FEDERATED IDENTITY MANAGEMENT

(71) Applicant: ELECTRONICS AND TELECOMMUNICATIONS RESEARCH INSTITUTE, Daejeon (KR)

(72) Inventors: Jae-Hoon NAH, Daejeon (KR); Sang-Woo LEE, Daejeon (KR)

(21) Appl. No.: 15/016,761

(22) Filed: Feb. 5, 2016

(30) Foreign Application Priority Data
Feb. 11, 2015 (KR) 10-2015-0021148
Feb. 4, 2016 (KR) 10-2016-0013906

(51) Int. Cl. H04L 29/06

(52) U.S. Cl. CPC H04L 63/0815

(57) ABSTRACT

Disclosed herein are a method and apparatus for providing authentication based on aggregated attributes in federated identity management. A federated identity system includes a user terminal, a server of a service provider, a first identity provision server, and a second identity provision server. The first identity provision server and the second identity provision server respectively provide attributes of a user's identity. The user terminal determines whether providing service to the user terminal is permissible, using the aggregated attributes. When it is determined that provision of the service is permissible, the user terminal acquires the service from the server of the service provider.

### CROSS REFERENCE TO RELATED APPLICATIONS

This application claims the benefit of Korean Patent Application No. 10-2015-0021148, filed Feb. 11, 2015, and No. 10-2016-0013906, filed Feb. 4, 2016, which are hereby incorporated by reference in their entirety into this application.

### BACKGROUND OF THE INVENTION

1. Technical Field

The following embodiments generally relate to a method and apparatus for authenticating a user. More particularly, a method and apparatus for providing authentication based on aggregated attributes in federated identity management are disclosed.

2. Description of the Related Art

A conventional federated identity (ID) model provides convenience to users based on core Single Sign-On (SSO) services.

Based on the infrastructure of the authentication and authorization service provided by the federated identity model, a user who is authenticated for one service may use other services without additionally having to be authenticated in the Internet environment, which includes multiple service providers.

This service has a service structure in which access to another domain and use of the service of the corresponding domain are allowed based on a single ID. However, this service has a limitation in a structure in which service is acquired from a single service provider using two IDs.

As a similar method for providing a service in which resources acquired from two domains are combined, OAuth 2.0 standards (IETF, August 2013) and Cross-Origin Resource Sharing (CORS) standards (W3C, January 2014) have been established, and technology related to the standards is also proliferating.

However, OAuth 2.0 is a service in which administration of access privileges is delegated to a third party. Meanwhile, in the case of CORS, a domain acquires information about another domain by changing a Hyper-Text Transfer Protocol (HTTP) header, and the use of a service in which data from the two domains are combined is allowed through the acquired information. In other words, the above-mentioned service breaks the Same Origin Policy (SOP).

As existing technology related to interconnection between two identity providers, U.S. Patent Application No. 2013/0276085 is disclosed.

### SUMMARY OF THE INVENTION

An embodiment may provide an apparatus and method for determining whether provision of service is appropriate using two or more identities in a federated identity environment.

An embodiment may provide an apparatus and method for determining whether provision of service is appropriate using aggregated attributes in a federated identity environment.

An embodiment may provide an apparatus and method for providing attributes that are additionally required in order to determine whether the provision of service is appropriate in a federated identity environment.

An embodiment may provide an apparatus and method for acquiring service using aggregated attributes in a federated identity environment.

According to an aspect of the present invention, there is provided a service provision method in which a server of a service provider provides service to a user terminal, the method including: receiving a request for the service from the user terminal; transmitting a request for authentication for the service to the user terminal; receiving authorization information including an aggregated attributes from the user terminal as a response for the request for authentication; determining whether it is permissible for the user terminal to access the service, using the aggregated attributes; and providing the service to the user terminal if it is permissible for the user terminal to access the service.

The aggregated attributes may be generated by aggregating a first attribute of a first identity of the user and a second attribute of a second identity of the user,

The first identity may be provided by a first identity provision server

The second identity may be provided by a second identity provision server.

The first identity provision server and the second identity provision server may be connected to a federated identity environment.

A domain of the first identity provision server and a domain of the second identity provision server may be different from each other.

According to another aspect of the present invention, there is provided a service acquisition method performed by a user terminal, the method including: transmitting a request for a service to a server of a service provider; receiving a request for authentication for the service from the server of the service provider; transmitting an authorization information including an aggregated attributes to the server of the service provider as a response for the request for authentication; and acquiring the service from the server of the service provider.

The service acquisition method may further include: receiving authorization assertion information from a first identity provision server; receiving attribute assertion information from a second identity provision server; and generating the aggregated attributes by aggregating a first attribute of the authorization assertion information and a second attribute of the attribute assertion information.

The first identity provision server and the second identity provision server may be connected to a federated identity environment.

A domain of the first identity provision server and a domain of the second identity provision server may be different from each other.

The authorization assertion information may be transmitted from the first identity provision server to the server of the service provider through a web browser executed in the user terminal

The authentication information may be transmitted to the server of the service provider through the web browser.

Whether it is permissible for the user terminal to access the service may be determined based on aggregated attributes.

The attribute assertion information may represent an attribute of the user that is required in addition to the authorization assertion information in order to determine whether the access to the service is permissible.

The authorization assertion information may represent a part of multiple attributes of the user that are required in order to determine whether the access to the service is permissible.

The service acquisition method may further include: recognizing that the authorization assertion information is not enough to satisfy requirements for providing the service, based on the authorization assertion information.

If the requirements for providing the service require another attribute of the user other than a first attribute that is represented by the authorization assertion information, the requirements for providing the service may be not satisfied.

The service acquisition method may include: transmitting the request for authentication to the first identity provision server; and transmitting the request for the attribute assertion information to the second identity provision server.

According to further aspect of the present invention, there is provided a service provision method in which a server of a service provider provides service to a user terminal, the method including: receiving authorization assertion information about the user terminal provided by a first identity provision server; receiving attribute assertion information about the user terminal provided by a second identity provision server; generating aggregated attributes using the authorization assertion information and the attribute assertion information; determining whether it is permissible for the user terminal to access the service, using the aggregated attributes; and providing the service to the user terminal if it is permissible for the user terminal to access the service.

The first identity provision server and the second identity provision server may be connected to a federated identity environment.

A domain of the first identity provision server and a domain of the second identity provision server may be different from each other.

The aggregated attributes may be generated by aggregating a first attribute of a first identity of the user and a second attribute of a second identity of the user.

The first identity may be provided by the first identity provision server.

The second identity may be provided by the second identity provision server.

The attribute assertion information may represent an attribute of the user that is required in addition to the authorization assertion information in order to determine whether access to the service is permissible.

The authorization assertion information may represent a part of multiple attributes of the user that are required in order to determine whether the access to the service is permissible.

The service provision method may further include recognizing that the authorization assertion information is not enough to satisfy requirements for providing the service, based on the authorization assertion information.

If the requirements for providing the service require another attribute of the user other than a first attribute that is represented by the authorization assertion information, the requirements for providing the service may not be satisfied.

According to further aspect of the present invention, there is provided a service acquisition method performed by a user terminal, the method including: transmitting authorization assertion information related to a first attribute of a user, which is required in order to acquire service provided by a server of a service provider, to the server of the service provider; receiving a request for additional information from the server of the service provider; transmitting attribute assertion information related to a second attribute of the user, which corresponds to the additional information and is required to acquire the service, to the server of the service provider; and acquiring the service from the server of the service provider.

The service acquisition method may further include receiving the authorization assertion information from a first identity provision server; and receiving the attribute assertion information from a second identity provision server.

The first identity provision server and the second identity provision server may be connected to a federated identity environment.

A domain of the first identity provision server and a domain of the second identity provision server may be different from each other.

The authorization assertion information may be transmitted from the first identity provision server to the server of the service provider through a web browser executed in the user terminal.

The attribute assertion information may be transmitted from the second identity provision server to the server of the service provider through the web browser.

Whether it is permissible for the user terminal to access the service may be determined based on aggregated attributes that are generated using the authorization assertion information and the attribute assertion information, provided by the server of the service provider.

The attribute assertion information may represent an attribute of the user that is required in addition to the authorization assertion information in order to determine whether the access to the service is permissible.

According to a further aspect of the present invention, there is provided a service provision method performed by an identity provision server, the method including: receiving a request for attribute assertion information from a user terminal; generating attribute assertion information; and transmitting the request for the attribute assertion information to the user terminal, wherein the attribute assertion information represents an attribute of a user that is required, in addition to authorization assertion information provided by an additional identity provision server, in order to determine whether it is permissible for the user terminal to access service.

The identity provision server and the additional identity provision server may be connected to a federated identity environment.

A domain of the identity provision server and a domain of the additional identity provision server may be different from each other.

In providing the attribute assertion information, the identity provision server may not request an additional authentication process from the user terminal by acquiring information related to authentication of the user through the federated identity environment.

The attribute assertion information may be requested when a server of a service provider that provides the service recognizes that the authorization assertion information is not enough to satisfy requirements for providing the service.

Additionally, there is further provided a computer-readable storage medium storing a computer program for implementing the above-mentioned methods, other methods, devices, and systems.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the structure of a service network in a federated identity environment;

FIG. 2 illustrates a system that provides authentication based on aggregated attributes in federated identity management;

FIG. 3 is a block diagram of a user terminal according to an embodiment;

FIG. 4 is a block diagram of a server of a service provider according to an embodiment;

FIG. 5 is a block diagram of a first identity provision server according to an embodiment;

FIG. 6 is a block diagram of a second identity provision server according to an embodiment;

FIG. 7 is a flowchart of a method for providing service according to an example;

FIG. 8 is a flowchart of a method for providing service according to an embodiment;

FIG. 9 describes the structure of a protocol for a user terminal according to an example;

FIG. 10 describes the structure of a protocol for the server of a service provider according to an example; and

FIG. 11 describes the structure of a protocol for a first identity provision server according to an example.

### DESCRIPTION OF THE PREFERRED EMBODIMENTS

Specific embodiments will be described in detail below with reference to the attached drawings. These embodiments are described in sufficient detail to enable those skilled in the art to practice the present invention. It should be understood that the embodiments differ from each other, but the embodiments do not need to be exclusive of each other. For example, a particular feature, structure, or characteristic described herein in connection with one embodiment may be implemented by another embodiment without departing from the spirit and scope of the present invention. Also, it should be understood that the location or arrangement of individual elements in the disclosed embodiments may be changed without departing from the spirit and scope of the present invention. Therefore, the following detailed description is not to be taken in a limiting sense, and if appropriately interpreted, the scope of the exemplary embodiments is limited only by the appended claims along with the full range of equivalents to which the claims are entitled.

The same reference numerals are used to designate the same or similar elements throughout the drawings. The shapes, sizes, etc. of components in the drawings may be exaggerated to make the description clear.

The terms used herein are for the purpose of describing particular embodiments only and are not intended to be limiting of the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element, or intervening elements may be present.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

Also, element modules described in the embodiments of the present invention are independently shown in order to indicate different characteristic functions, and but this does not mean that each of the element modules is formed of a separate piece of hardware or software. That is, element modules are arranged and included, for convenience of description, and at least two of the element units may form one element unit or one element may be divided into multiple element units and the multiple element units may perform functions. An embodiment into which the elements are integrated or an embodiment from which some elements are separated is included in the scope of the present invention as long as it does not depart from the essence of the present invention.

Also, in the present invention, some elements are not essential elements for performing essential functions, but may be optional elements for improving only performance. The present invention may be implemented using only essential elements for implementing the essence of the present invention, excluding elements used to improve only performance, and a structure including only essential elements, excluding optional elements used only to improve performance, is included in the scope of the present invention.

Hereinafter, embodiments of the present invention are described with reference to the accompanying drawings in order to describe the present invention in detail so that those having ordinary knowledge in the technical field to which the present invention pertains can easily practice the present invention. In the following description of the present invention, detailed descriptions of known functions and configurations which are deemed to make the gist of the present invention obscure will be omitted.

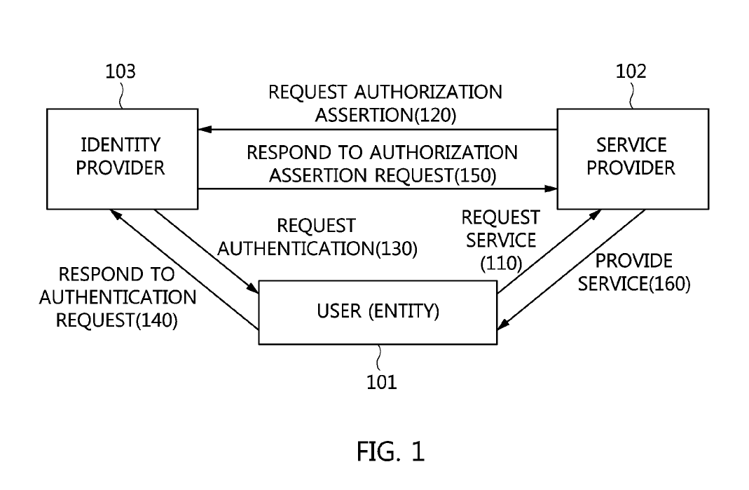

FIG. 1 shows the structure of a service network in a federated identity environment.

Identity management technology is technology that provides all the functions for managing information about the identity of a user. The functions for managing identity information may include creating, registering, storing, updating, and deleting identity information. Identity management technology is foundational technology that is essential to protect personal information.

Identity management technology has sequentially developed into a silo model, a centralized identity management model, and a federated identity management model. A silo model may be related to technology that enables a site to provide its own identity management functions, and as an example of a centralized identity management model, there is Passport.

Recently, an identity management model based on a user has been developed as identity management technology.

FIG. 1 illustrates the structure of a service network for federated identity management and the flow of data processing therein.

A federated identity system may include a user 101, a Service Provider (SP) 102, and an Identity Provider (IdP) 103. The user may be called an entity.

The user 101 may be identified by an ID in the service network structure. The ID may be composed of at least one attribute of the user 101. For example, the ID may include at least one attribute of the user 101. Hereinafter, the terms “attribute” and “attribute information” may be used as having the same meaning, and they may be interchangeable with each other.

For example, an attribute may include information such as the name of a user, the sex of a user, the identifier of a user, the occupation of a user, the hobby of a user, and the like.

The SP 102 may determine whether to allow a user 101 to access service, based on the authorization assertion of the IdP 103. The SP 102 may determine whether to allow the access to the service, based on the attribute of the authorization assertion.

The IdP 103 may authenticate a user 101, and may manage the ID and attributes of the user 101. Here, the management may include creating, updating, disclosing and deleting the ID or the attributes.

Hereinafter, the flow of data processing for providing the service of a federated identity system is described.

First, the user 101 may transmit a request for service to the SP 102 at step 110.

Here, the SP 102 needs to check whether the service requested by the user 101 is allowed to be provided to the user.

Subsequently, the SP 102 may transmit a request for the authorization assertion for the service to the IdP 103 at step 120 in order to check whether the service is allowed to be provided to the user.

Subsequently, the IdP 103 may transmit the request for authentication to the user 101 at step 130.

Subsequently, the user 101 may transmit a response to the request for authentication to the IdP 103 at step 140.

The response to the request for authentication may include personal information that is required for authentication. Here, the personal information may be the credentials of the user 101.

The IdP 103 may authenticate the user using the personal information. As a result, the IdP 103 may generate the information to be used for determining whether the user 101 can access the service in the form of the authorization assertion.

Subsequently, the IdP 103 may transmit the response to the request for the authorization assertion to the SP 102 at step 150.

Based on the authorization assertion, the IdP 103 may determine the suitability of providing the service to the user 101.

Subsequently, when it determines that providing the service to the user 101 is permissible, the IdP 103 may provide the service to the user 101 at step 160.

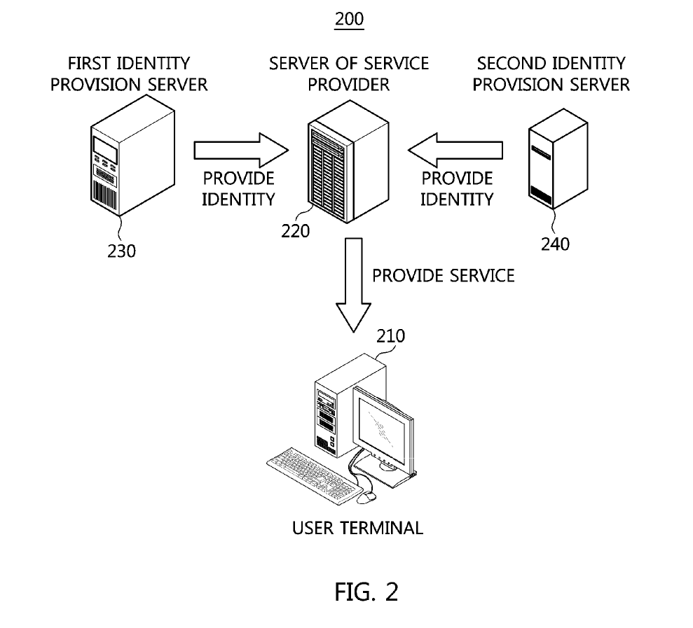

FIG. 2 illustrates a system that provides authentication based on aggregated attributes in federated identity management.

A federated identity system 200 may include at least some of a user terminal 210, a server of a service provider 220, a first identity provision server 230, and a second identity provision server 240.

The user terminal 210 may correspond to the user 101, which was described above with reference to FIG. 1. The characteristics, operation, and functions pertaining to the user 101, described above with reference to FIG. 1, may also be applied to the user terminal 210.

The server of the service provider 220 may correspond to the SP 102, which was described above with reference to FIG. 1. The characteristics, operation, and functions of the SP 102, described above with reference to FIG. 1, may also be applied to the server of the service provider 220. The server of the service provider 220 may provide the user terminal 210 with the service requested by the user terminal 210.

The first identity provision server 230 may correspond to the IdP 103, which was described above with reference to FIG. 1. The characteristics, operation, and functions of the IdP 103, described above with reference to FIG. 1, may also be applied to the first identity provision server 230. The first identity provision server 230 may provide an ID to the server of the service provider 220.

The second identity provision server 240 may correspond to the IdP 103, which was described above with reference to FIG. 1. The characteristics, operation, and functions of the IdP 103, described above with reference to FIG. 1, may also be applied to the second identity provision server 240. The second identity provision server 240 may provide an ID to the server of the service provider 220.

The first identity provision server 230 may be included in a domain that differs from the domain in which the second identity provision server 240 is included.

A federated identity environment provides a Single Sign-On (SSO), in which logging on to one domain for requesting service therein enables provision of service from another domain without an additional authentication process when the service from the other domain is requested.

Generally, in such a federated identity environment, an identity provision server may determine the suitability of providing service using the attributes of a single ID. However, when only the attributes included in the single ID are used, there may be a limitation in providing service or in determining the suitability of providing the service. In order to overcome this limitation, each of the first identity provision server 230 and the second identity provision server 240 may additionally aggregate the attributes of the identity of a user.

Examples of a service to which such an authentication model may be applied are as follows.

For example, when a user wants to buy a bottle of wine on the internet using a general identity, a process for checking whether the user is an adult is required. Here, there may be the case in which the first ID, which is used merely to log in to a wine sales service, cannot be used to confirm that the user is an adult. Accordingly, the second ID, which is capable of confirming that the user is an adult, is used for the confirmation, and then the user can buy the bottle of wine. Therefore, it is necessary to improve the service so that buying wine is possible using only the first ID.

As another example, when a user buys a book from an e-book site, the user may be provided with a reduced rate if the user is a member of a specific academic society. In this case, if both the first ID for the e-book site and the second ID for the academic society are provided, the e-book site may provide the reduced rate by checking the attributes of the two IDs.

The first identity provision server 230 and the second identity provision server 240 may provide the service described in the above-mentioned example, and for this, they may be interconnected.

An embodiment proposes a service structure in which two or more IDs are used, and provides an improved and/or enhanced authentication model in which service of one domain is combined with that of another domain.

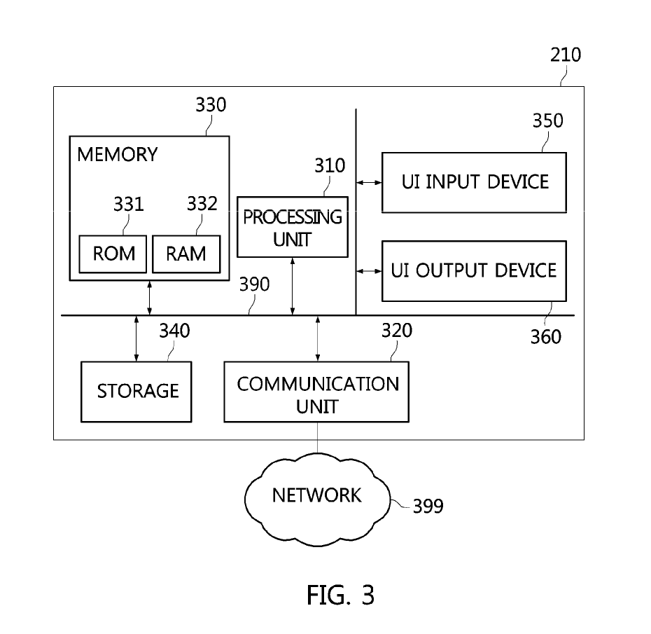

FIG. 3 is a block diagram of a user terminal according to an embodiment.

The user terminal 210 may include at least some of a processing unit 310, a communication unit 320, memory 330, storage 340, and a bus 390. The components of the user terminal 210, such as the processing unit 310, the communication unit 320, the memory 330, and the storage 340, may communicate with each other via the bus 390.

The processing unit 310 may be a semiconductor device for executing processing instructions stored in the memory 330 or the storage 340. For example, the processing unit 310 may be at least one processor.

The processing unit 310 may process tasks required for the operation of the user terminal 210. The processing unit 310 may execute code of the operation or steps of the processing unit 310, which will be described in the embodiments.

The communication unit 320 may be connected to a network 399. The communication unit 320 may receive and transmit data or information required for the operation of the user terminal 210. The communication unit 320 may transmit data to other devices via the network 399, and may receive data from other devices. For example, the communication unit 320 may be a network chip or a port.

The memory 330 and the storage 340 may be various types of volatile or non-volatile storage media. For example, the memory 330 may include at least one of ROM 331 and RAM 332. The storage 340 may include embedded storage media such as RAM, flash memory, and a hard disk, and may also include detachable storage media such as a memory card.

The function or operation of the user terminal 210 may be performed in such a way that the processing unit 310 executes at least one program module. The memory 330 and/or the storage 340 may store at least one program module. The at least one program module may be configured to be executed by the processing unit 310.

The user terminal 210 may further include a User Interface (UI) input device 350 and a UI output device 360. The UI input device 350 may receive the input, required for the operation of the user terminal 210, from a user. The UI output device 360 may output information or data depending on the operation of the user terminal 210.

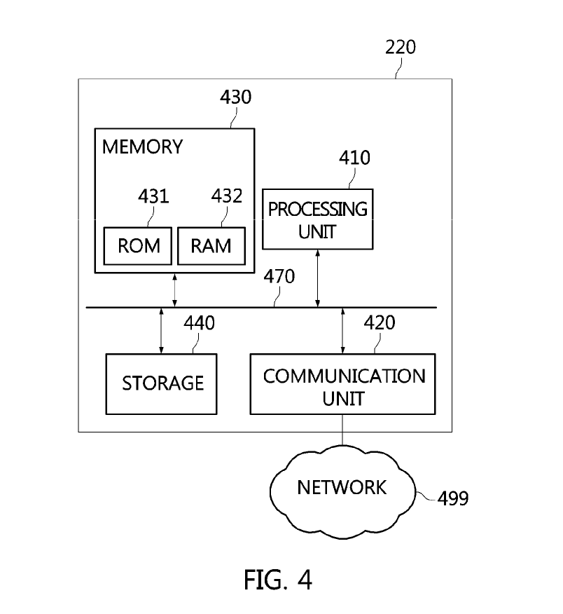

FIG. 4 is a block diagram of the server of a service provider according to an embodiment.

The server of the service provider 220 may include at least some of a processing unit 410, a communication unit 420, memory 430, storage 440, and a bus 490. The components of the server of the service provider 220, such as the processing unit 410, the communication unit 420, the memory 430, and the storage 440, may communicate with each other via the bus 490.

The processing unit 410 may be a semiconductor device for executing processing instructions stored in the memory 430 or the storage 440. For example, the processing unit 410 may be at least one processor.

The processing unit 410 may process tasks required for the operation of the server of the service provider 220. The processing unit 410 may execute code of the operation or steps of the processing unit 410, which will be described in the embodiments.

The communication unit 420 may be connected to a network 499. The communication unit 420 may receive and transmit data or information required for the operation of the server of the service provider 220. The communication unit 420 may transmit data to other devices via the network 499, and may receive data from other devices. For example, the communication unit 420 may be a network chip or a port.

The memory 430 and the storage 440 may be various types of volatile or non-volatile storage media. For example, the memory 430 may include at least one of ROM 431 and RAM 432. The storage 440 may include embedded storage media such as RAM, flash memory, and a hard disk, and may also include detachable storage media such as a memory card.

The function or operation of the server of the service provider 220 may be performed in such a way that the processing unit 410 executes at least one program module. The memory 430 and/or the storage 440 may store at least one program module. The at least one program module may be configured to be executed by the processing unit 410.

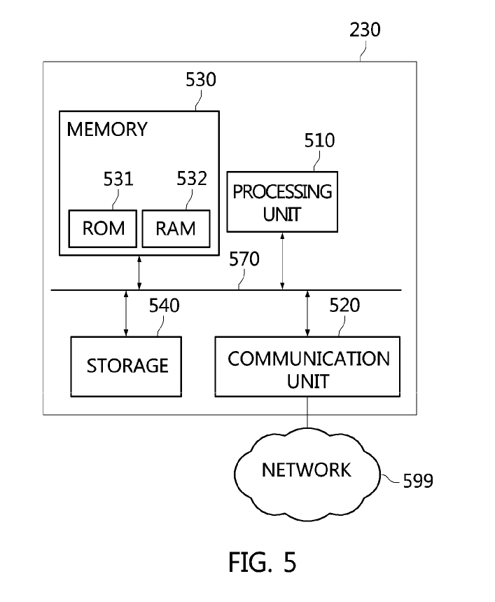

FIG. 5 is a block diagram of a first identity provision server according to an embodiment.

The first identity provision server 230 may include at least some of a processing unit 510, a communication unit 520, memory 530, storage 540, and a bus 590. The components of the first identity provision server 230, such as the processing unit 510, the communication unit 520, the memory 530, and the storage 540, may communicate with each other via the bus 590.

The processing unit 510 may be a semiconductor device for executing processing instructions stored in the memory 530 or the storage 540. For example, the processing unit 510 may be at least one processor.

The processing unit 510 may process tasks required for the operations of the first identity provision server 230. The processing unit 510 may execute code of the operation or steps of the processing unit 510, which will be described in the embodiments.

The communication unit 520 may be connected to a network 599. The communication unit 520 may receive and transmit data or information required for the operation of the first identity provision server 230. The communication unit 520 may transmit data to other devices via the network 599 and may receive data from other devices. For example, the communication unit 520 may be a network chip or a port.

The memory 530 and the storage 540 may be various types of volatile or non-volatile storage media. For example, the memory 530 may include at least one of ROM 531 and RAM 532. The storage 540 may include embedded storage media such as RAM, flash memory, and a hard disk, and may also include detachable storage media such as a memory card.

The function or operation of the first identity provision server 230 may be performed in such a way that the processing unit 510 executes at least one program module. The memory 530 and/or the storage 540 may store at least one program module. The at least one program module may be configured to be executed by the processing unit 510.

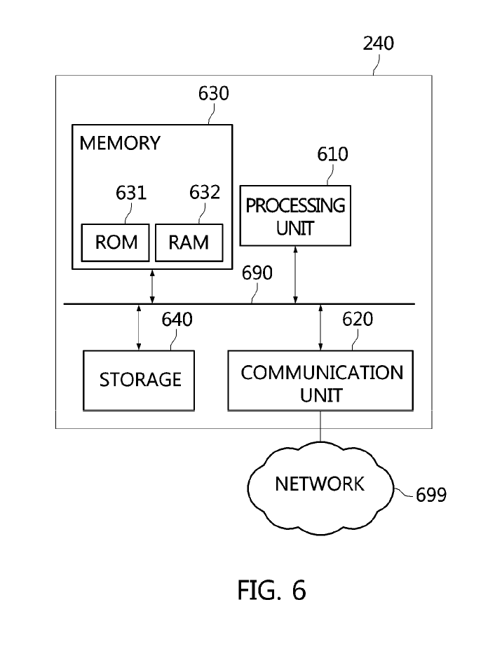

FIG. 6 is a block diagram of a second identity provision server according to an embodiment.

The second identity provision server 240 may include at least some of a processing unit 610, a communication unit 620, memory 630, storage 640, and a bus 690. The descriptions of the processing unit 510, the communication unit 520, the memory 530, the storage 540, and the bus 590, which were made with reference to FIG. 5, may respectively be applied to the processing unit 610, the communication unit 620, the memory 630, the storage 640, and the bus 690. Repeated descriptions will be omitted.

The communication unit 620 may be connected to a network 699.

At least some of the networks 399, 499, 599, and 699, described above with reference to FIGS. 3 to 6, may be the same network. Also, the networks 399, 499, 599, and 699 may be networks in domains that differ from each other. Also, the networks 399, 499, 599, and 699 may be connected with each other.

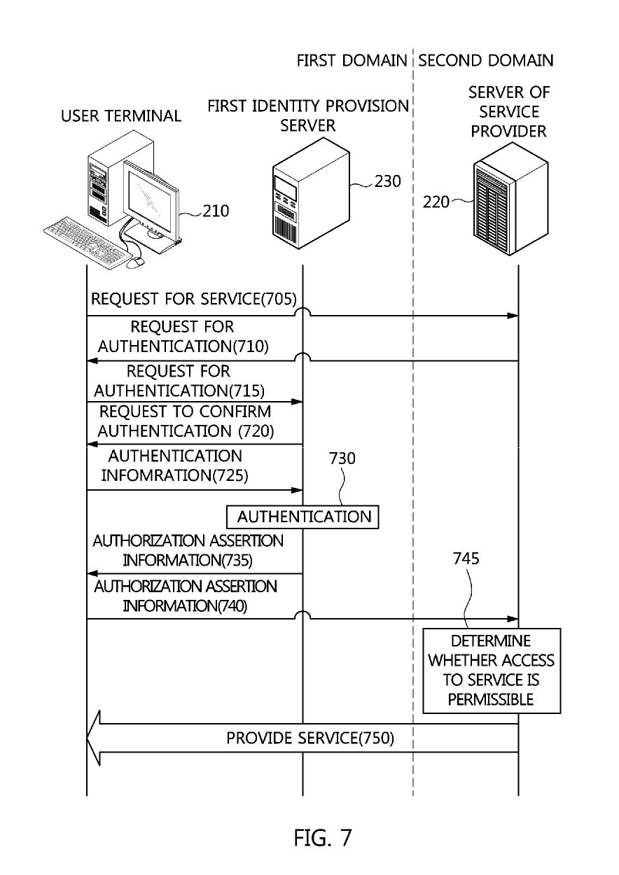

FIG. 7 is a flowchart of a method for providing service according to an example.

In an embodiment of FIG. 7, a federated identity system 200 may provide SSO as the main service.

The following embodiment describes the case in which whether service is allowed to be provided to a user is determined using an identity provided by a single identity provision server.

The user terminal 210 and the first identity provision server 230 may be included in the first domain. The server of the service provider 220 may be included in the second domain. The user terminal 210 may request service from the server of a service provider 220 that is included in a domain that differs from the domain in which the user terminal 210 is included.

At step 705, the communication unit 320 of the user terminal 210 transmits a request for service to the server of the service provider 220. The communication unit 420 of the server of the service provider 220 may receive the request for the service from the user terminal 210.

When it receives the request for the service, the processing unit 410 of the server of the service provider 220 needs to check whether the requested service is allowed to be provided to the user terminal 210. In order to check whether the requested service is allowed to be provided to the user terminal 210, steps 710, 715, 720, 725, 730, 735, 740, and 745 may be performed.

At step 710, the communication unit 420 of the server of the service provider 220 may transmit a request for authentication to the user terminal 210. The communication unit 320 of the user terminal 210 may receive the request for authentication from the server of the service provider 220.

A web browser, executed by the processing unit 310 in the user terminal 210, may receive the request for authentication. The processing unit 310 or the web browser may recognize that the request for authentication is an authentication message that needs to be transmitted to the first identity provision server 230, which is the identity provider of the domain in which the user terminal 210 is included.

When it recognizes that the request for authentication is an authentication message that needs to be transmitted to the first identity provision server 230, the communication unit 320 of the user terminal 210 may transmit the request for authentication to the first identity provision server 230 at step 715. The communication unit 520 of the first identity provision server 230 may receive the request for authentication from the user terminal 210.

Through steps 710 and 715, the request for authentication may be transmitted from the server of the service provider 220 to the first identity provision server 230 via the web browser of the user terminal 210.

When it receives the request for authentication, the processing unit 510 of the first identity provision server 230 needs to acquire authentication information in order to authenticate the user terminal 210. In order to acquire the authentication information, steps 720 and 725 may be performed.

At step 720, the communication unit 520 of the first identity provision server 230 may transmit the request to confirm authentication to the user terminal 210. The communication unit 320 of the user terminal 210 may receive the request to confirm authentication from the first identity provision server 230.

At step 725, a user may input personal information through the UI input device 350 of the user terminal 210 in response to the request to confirm authentication. The personal information may be the credentials of the user. Also, the personal information may include a user name and a user password.

In response to the request to confirm authentication, the communication unit 320 of the user terminal 210 may transmit authentication information to the first identity provision server 230. The communication unit 520 of the first identity provision server 230 may receive the authentication information from the user terminal 210.

The authentication information may include the personal information.

At step 730, the processing unit 510 of the first identity provision server 230 may authenticate the user terminal 210 using the personal information.

The processing unit 510 may generate authorization assertion information about the user terminal 210 as a result of authenticating the user terminal 210.

At step 735, the communication unit 520 of the first identity provision server 230 may transmit the authorization assertion information to the user terminal 210. The communication unit 320 of the user terminal 210 may receive the authorization assertion information from the first identity provision server 230.

The web browser executed in the user terminal 210 may receive the authorization assertion information. The processing unit 310 or the web browser may recognize that the authorization assertion information needs to be transmitted to the server of the service provider 220 that transmitted the request for authentication.

At step 740, the communication unit 320 of the user terminal 210 may transmit the authorization assertion information to the server of the service provider 220. The communication unit 420 of the server of the service provider 220 may receive the authorization assertion information from the user terminal 210.

Through steps 735 and 740, the authorization assertion information may be transmitted from the first identity provision server 230 to the server of the service provider 220 via the user terminal 210. The communication unit 420 of the server of the service provider 220 may receive the authorization assertion information for the user terminal 210 that was provided by the first identity provision server.

At step 745, the processing unit 410 of the server of the service provider 220 may determine whether it is appropriate for the user terminal 210 to access the service, based on the authorization assertion information. If it is appropriate for the user terminal 210 to access the service, step 750 may be performed.

At step 750, the server of the service provider 220 may provide the requested service to the user terminal 210. The user terminal 210 may receive the information about the service provided from the server of the service provider 220, through the communication unit 320.

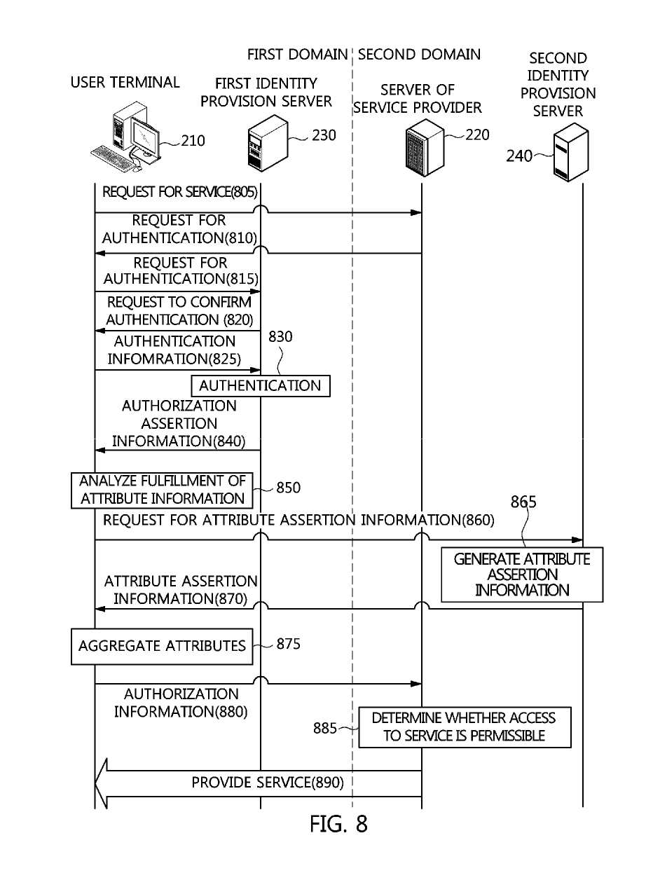

FIG. 8 is a flowchart of a method for providing service according to an embodiment.

In an embodiment of FIG. 8, the federated identity system 200 may provide SSO as the main service.

The following embodiment describes the case in which whether service can be provided to a user is determined using identities provided by two identity provision servers.

The user terminal 210 and the first identity provision server 230 may be included in the first domain. The server of the service provider 220 and the second identity provision server 240 may be included in the second domain. The domain that includes the first identity provision server 230 may be different from the domain that includes the second identity provision server 240. The user terminal 210 may request service from a server of a service provider 220 that is included in a domain other than the domain in which the user terminal 210 is included.

At step 805, the communication unit 320 of the user terminal 210 transmits a request for service to the server of the service provider 220. The communication unit 420 of the server of the service provider 220 may receive the request for the service from the user terminal 210.

When it receives the request for the service, the processing unit 410 of the server of the service provider 220 needs to check whether the requested service is allowed to be provided to the user terminal 210. In order to check whether the requested service is allowed to be provided to the user terminal 210, steps 810, 815, 820, 825, 830, 840, 850, 860, 865, 870, 875, 880, and 890 may be performed.

At step 810, the communication unit 420 of the server of the service provider 220 may transmit the request for authentication required for the request for the service to the user terminal 210. The communication unit 320 of the user terminal 210 may receive the request for authentication from the server of the service provider 220.

The request of authentication may include information of a required attribute for a provision of the service. The required attribute may be plural. That is to say, for the provision of the requested service, the plurality of the required attributes may be provided to the server of the service provider 220.

A web browser executed by the processing unit 310 in the user terminal 210 may receive the request for authentication. The processing unit 310 or the web browser may recognize that the request for authentication is an authentication message that is required to be transmitted to the first identity provision server 230, which is the identity provider of the domain in which the user terminal 210 is included.

When it recognizes that the request for authentication is an authentication message that needs to be transmitted to the first identity provision server 230, the communication unit 320 of the user terminal 210 may transmit the request for authentication to the first identity provision server 230 at step 815. The communication unit 520 of the first identity provision server 230 may receive the request for authentication from the user terminal 210.

Through steps 810 and 815, the request for authentication may be transmitted from the server of the service provider 220 to the first identity provision server 230 via the web browser of the user terminal 210.

When it receives the request for authentication, the processing unit 510 of the first identity provision server 230 needs to acquire authentication information in order to authenticate the user terminal 210. In order to acquire the authentication information, steps 820 and 825 may be performed.

At step 820, the communication unit 520 of the first identity provision server 230 may transmit a request to confirm authentication to the user terminal 210. The communication unit 320 of the user terminal 210 may receive the request to confirm authentication from the first identity provision server 230.

At step 825, a user may input personal information through the UI input device 350 of the user terminal 210 in response to the request to confirm authentication. The personal information may be the credentials of the user. Also, the personal information may include a user name and a user password.

In response to the request to confirm authentication, the communication unit 320 of the user terminal 210 may transmit authentication information to the first identity provision server 230. The communication unit 520 of the first identity provision server 230 may receive the authentication information from the user terminal 210.

The authentication information may include the personal information.

At step 830, the processing unit 510 of the first identity provision server 230 may authenticate the user terminal 210 using the personal information.

The processing unit 510 may generate authorization assertion information for the user terminal 201 as a result of authenticating the user terminal 210. For example, the processing unit 510 may generate the authorization assertion information when authentication of the user terminal 210 succeeds.

The authorization assertion information may represent information about the first attribute of the user of the user terminal 210. The authorization assertion information may represent those among the user's multiple attributes that are required in order to determine whether access to the service is permissible.

Alternatively, the authorization assertion information may include information about the first attribute of the first ID of the user of the user terminal 210. The first attribute may comprise multiple attributes. Alternatively, the authorization assertion information may include information about the first ID.

At step 840, the communication unit 520 of the first identity provision server 230 may transmit the authorization assertion information to the user terminal 210. The communication unit 320 of the user terminal 210 may receive the authorization assertion information from the first identity provision server 230.

The web browser executed in the user terminal 210 may receive the authorization assertion information. The processing unit 310 or the web browser may recognize that the authorization assertion information needs to be transmitted to the server of the service provider 220 that transmitted the request for authentication.

At step 850, the processing unit 310 of the user terminal 210 may analyze whether the attribute information is fulfilled.

The processing unit 310 may analyze whether the first attribute of the authorization assertion information includes all of the required attribute for the service.

If the first attribute of the authorization assertion information doesn't include all of the required attribute for the service, then an additional attribute may be required for the provision of the service.

Base on the analyzation, the processing unit 310 may determine the additional attribute required for the service. The addition attribute is attribute that doesn't correspond to the first attribute(s) of the authorization assertion information among required attribute(s) for the service that is a target of the request of authentication.

The processing unit 310 may select an identity provision server corresponding to the additional attribute from among the identity provision servers that are capable of communicating with the user terminal 210, by analyzing the additional attribute.

By analyzing the additional attribute, the processing unit 310 may recognize that the identity that includes the additional attribute is managed by another identity provision server, that is, the second identity provision server 240. Accordingly, among the identity provision servers, the processing unit 310 may select the second identity provision server 240 that manages the identity that includes the additional attribute as the server to which the request for attribute assertion information is to be transmitted.

The processing unit 310 may output a message, saying that additional information is being requested, using the UI output device 360. In this case, the additional information may be the additional attribute. The user may thus realize that the additional information is being requested through the UI output device 360. The user may indicate agreement to the provision of the additional information using the UI input device 350. The processing unit 310 may detect that the user agrees to provide the additional information by recognizing the information input through the UI input device 350. In other words, in an embodiment, the provision of the additional information and the addition of the attributes by the provision of the additional information may or may not be performed depending on the selection of the user. Therefore, the private information of the user may be effectively protected thanks to the characteristic configuration of the embodiment.

At step 860, the communication unit 320 of the user terminal 210 may transmit a request for attribute assertion information to the second identity provision server 240. The communication unit 620 of the second identity provision server 240 may receive the request for the attribute assertion information from the user terminal 210.

In the second identity provision server 240, the request for the attribute assertion information may be received when the user terminal 210 or the server of the service provider 220 realizes that the authorization assertion information is not enough to satisfy the requirements for providing the service.

The request for the attribute assertion information may include personal information. The personal information at step 860 may differ from the personal information at step 825. For example, the personal information at step 860 may include information for identifying the user.

The request for the attribute assertion information may include information about the required additional attribute. For example, the attribute assertion information may include information that represents which attributes are additionally required to provide the service and information related to the attributes that are required to be presented in the attribute assertion information.

At step 865, the processing unit 610 of the second identity provision server 240 may generate the attribute assertion information about the user.

The attribute assertion information may related to a second attribute of the user of the user terminal 210 that is required to obtain the service provided by the server of the service provider 220.

The attribute assertion information may represent the information about the second attribute of the user of the user terminal 210. The attribute assertion information may represent the user's attributes that are required in addition to the authorization assertion information provided by the first identity provision server 230, in order to determine whether the access to the service is appropriate.

Alternatively, the attribute assertion information may include information about the second attribute of the second ID. The second attribute may comprise multiple attributes. Alternatively, the attribute assertion information may include information about the second ID of the user.

The first identity provision server 230 and the second identity provision server 240 may be connected to the federated identity environment in advance. The second identity provision server 240 may acquire information related to authentication of the user through the federated identity environment and/or the first identity provision server 230. Accordingly, the second identity provision server 240 does not request an additional authentication process from the user terminal 210 when it generates and provides the attribute assertion information. Therefore, compared to the method in which an additional attribute is provided through existing SSO, the characteristic configuration of the embodiment does not require an ineffective additional authentication process. Consequently, the embodiment may operate more effectively than the existing method.

At step 870, the communication unit 630 of the second identity provision server 240 may transmit the attribute assertion information to the user terminal 210. The communication unit 320 of the user terminal 210 may receive the attribute assertion information from the second identity provision server 240.

The web browser executed in the user terminal 210 may receive the attribute assertion information.

At step 875, the processing unit 310 of the user terminal 210 may aggregate the attributes from the received attribute assertion information. The processing unit 310 may generate the authorization information by performing an attribute assertion aggregation for the transferred attribute assertion information.

The processing unit 310 may be generated an aggregated attribute by aggregating the attributes of the authorization assertion information, transmitted at step 840, and the attributes of the attribute assertion information, transmitted at step 875. That is, the aggregated attributes may be aggregated from both the authorization assertion information and the attribute assertion information. The aggregated attributes may be generated by aggregating the first attribute of the first identity of the user and the second attribute of the second identity of the user.

The processing unit 310 may generate the authorization information. The authorization information may represent information of the aggregated attribute of the user of the user terminal 210.

The authorization information may represent the plurality of attributes of the user that are required in order to determine whether the access to the service is appropriate. Or, authorization information may represent the aggregated attribute of the user of the user terminal 210.

The processing unit 310 or the web browser may recognize that the authorization information needs to be transmitted to the server of service provider 220 that transmitted the request for the authentication.

At step 880, the communication unit 320 of the user terminal 210 may transmit the authentication information as a response for the request for authentication to the server of the service provider 220. The communication unit 420 of the server of the service provider 220 may receive the authentication information as the response for the request for authentication from the user terminal 210.

At step 885, the processing unit 410 of the server of the service provider 220 may determine whether it is appropriate for the user terminal 210 to access the service based on the aggregated attributes of the authorization information. That is, in terms of the user terminal 210, whether it is appropriate for the user terminal 210 to access the service may be determined using the aggregated attributes, which are generated by the user terminal 210 using the authorization assertion information and the attribute assertion information.

If it is appropriate for the user terminal 210 to access the service, step 890 may be performed.

At step 890, if it is appropriate for the user terminal 210 to access the service, the processing unit 410 of the server of the service provider 220 may provide the requested service to the user terminal 210, through the communication unit 420.

The user terminal 210 may acquire the service from the server of the service provider 220. The user terminal may 210 may receive the information about the service provided by the server of the service provider 220 through the communication unit 320.

According to the above-described embodiment, searching for an ID for the information about the attributes may be performed based on a user or a user terminal 210. Also, according to the above-described embodiment, the information about the attributes may be effectively provided.

The descriptions with reference to FIGS. 1 to 7 may be applied to the present embodiment. Repeated descriptions will be omitted.

The step 850 previously described may be performed by the server of the service provider 220. In such case, the authorization assertion information may be delivered from the web browser of the user terminal 210 to the server of the service provider 220. And, the request for the attribute assertion information may be generated by the server of the service provider 220. The server of the service provider 220 may transmit the request for the attribute assertion information to the user terminal 210.

And, the user terminal 210 may transmit the attribute assertion to the server of the service provider 220. In such case, the step 875 may be performed by the server of the service provider 220, and the step 880 may be omitted.

And, the authorization information may be interpreted as an authorization assertion information in response to the request of the service for the server of the service provider 220.

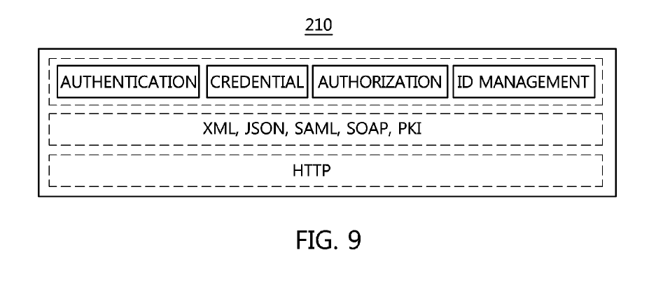

FIG. 9 describes the structure of a protocol for a user terminal according to an example.

FIG. 9 shows the conceptual structure of the protocol that enables the user terminal 210 to practically transmit information in a network environment.

In the lower layer, there may be a Hyper-Text Transfer Protocol (HTTP) as the lowest transfer protocol in order to transfer data between the user terminal 210, the server of the service provider 220, the first identity provision server 230, and the second identity provision server 240.

In the intermediate layer, there is the upper layer protocol of HTTP. As a protocol of the intermediate layer, there may be eXtensible Markup Language (XML), which represents the document format for exchanging data, and JavaScript Object Notation (JSON). Also, as a protocol of the intermediate layer, there may be Security Assertion Markup Language (SAML), Simple Object Access Protocol (SOAP), and Public Key Infrastructure (PKI).

Also, in the upper layer, there may be applications for providing a web service based on the above-mentioned basic layers. As the applications, there are an application for authentication, an application for credentials, an application for authorization, and an application for managing IDs.

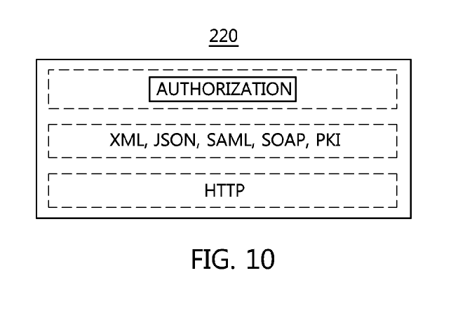

FIG. 10 describes the structure of a protocol of the server of the service provider according to an example.

FIG. 10 shows the conceptual structure of the protocol that enables the server of the service provider 220 to practically transmit information in a network environment.

In the lower layer, there may be a Hyper-Text Transfer Protocol (HTTP) as the lowest transfer protocol in order to transfer data between the user terminal 210, the server of the service provider 220, the first identity provision server 230, and the second identity provision server 240.

In the intermediate layer, there is the upper layer protocol of HTTP. As a protocol of the intermediate layer, there may be eXtensible Markup Language (XML), which represents the document format for exchanging data, and JavaScript Object Notation (JSON). Also, as a protocol of the intermediate layer, there may be Security Assertion Markup Language (SAML), Simple Object Access Protocol (SOAP), and Public Key Infrastructure (PKI).

Also, in the upper layer, there may be an application for authorization, based on the above-mentioned two basic layers.

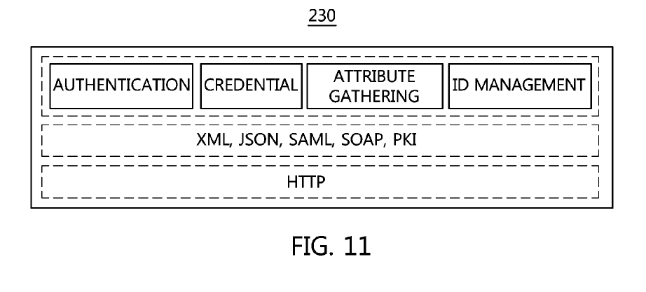

FIG. 11 describes the protocol of a first identity provision server according to an example.

FIG. 11 shows the conceptual structure of the protocol that enables the first identity provision server 230 to practically transmit information in a network environment.

In the lower layer, there may be a Hyper-Text Transfer Protocol (HTTP) as the lowest transfer protocol in order to transfer data between the user terminal 210, the server of the service provider 220, the first identity provision server 230, and the second identity provision server 240.

In the intermediate layer, there is the upper layer protocol of HTTP. As a protocol of the intermediate layer, there may be eXtensible Markup Language (XML), which represents the document format for exchanging data, and JavaScript Object Notation (JSON). Also, as a protocol of the intermediate layer, there may be Security Assertion Markup Language (SAML), Simple Object Access Protocol (SOAP), and Public Key Infrastructure (PKI).

Also, in the upper layer, there may be applications for providing a web service based on the above-mentioned basic layers. As the applications, there are an application for authentication, an application for credentials, an application for gathering attributes, and an application for managing IDs.

The above-described structure of the protocol for the first identity provision server 230 may be applied to the structure of the protocol for the second identity provision server 240. Repeated descriptions will be omitted.

The device described herein may be implemented using hardware components, software components, or a combination thereof. For example, the device and components described in the embodiments may be implemented using one or more general-purpose or special purpose computers, for example, a processor, a controller, an arithmetic logic unit (ALU), a digital signal processor, a microcomputer, a field programmable array (FPA), a programmable logic unit (PLU), a microprocessor or any other device capable of responding to and executing instructions. The processing device may run an operating system (OS) and one or more software applications that run on the OS. The processing device may also access, store, manipulate, process, and create data in response to execution of the software. For convenience of understanding, the use of a single processing device is described, but those skilled in the art will understand that a processing device may comprise multiple processing elements and multiple types of processing elements. For example, a processing device may include multiple processors or a single processor and a single controller. Also, different processing configurations, such as parallel processors, are possible.

The software may include a computer program, code, instructions, or some combination thereof, and it is possible to configure processing devices or to independently or collectively instruct the processing devices to operate as desired. Software and data may be embodied permanently or temporarily in any type of a machine, a component, physical or virtual equipment, a computer storage medium, a device, or in a propagated signal wave in order to provide instructions or data to the processing devices or to be interpreted by the processing devices. The software may also be distributed in computer systems over a network such that the software is stored and executed in a distributed method. In particular, the software and data may be stored in one or more computer readable recording media.

The above-described embodiments may be implemented as a program that can be executed by various computer means. In this case, the program may be recorded on a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

There is provided an apparatus and method for determining whether the provision of service is permissible using two or more identities in a federated identity environment.

There is provided an apparatus and method for determining whether the provision of service is permissible using aggregated attribute in a federated identity environment.

There is provided an apparatus and method for providing attributes that are additionally required in order to determine whether the provision of service is permissible in a federated identity environment.

There is provided an apparatus and method for acquiring service using aggregated attributes in a federated identity environment.

Searching for an identity for attribute information may be performed based on a user, and attribute information may be effectively provided.

Because a user may decide whether or not to add attribute information, private user information is effectively protected.

Compared to the provision of additional attribute information using existing SSO, an ineffective authentication process is not required.

Compared to an existing federated identity structure, changes in the flow of operations are minimized.

Although the preferred embodiments of the present invention have been disclosed for illustrative purposes, those skilled in the art will appreciate that various modifications, additions and substitutions are possible. For example, suitable results may be achieved if the described techniques are performed in a different order and/or if components in a described system, architecture, device, or circuit are combined in a different manner and/or replaced or supplemented by other components or their equivalents.

What is claimed is:

1. A service provision method in which a server of a service provider provides service to a user terminal, the method comprising:
receiving a request for the service from the user terminal;
transmitting a request for authentication for the service to the user terminal;
receiving authorization information including an aggregated attributes from the user terminal as a response for the request for authentication;
determining whether it is permissible for the user terminal to access the service, using the aggregated attributes; and
providing the service to the user terminal if it is permissible for the user terminal to access the service.

2. The service provision method of claim 1, wherein the aggregated attributes are generated by aggregating a first attribute of a first identity of the user and a second attribute of a second identity of the user,
the first identity is provided by a first identity provision server, and
the second identity is provided by a second identity provision server.

3. The service provision method of claim 2, wherein the first identity provision server and the second identity provision server are connected to a federated identity environment.

4. The service provision method of claim 2, wherein a domain of the first identity provision server and a domain of the second identity provision server are different from each other.

5. A service acquisition method performed by a user terminal, the method comprising:
transmitting a request for a service to a server of a service provider;
receiving a request for authentication for the service from the server of the service provider;
transmitting an authorization information including an aggregated attributes to the server of the service provider as a response for the request for authentication; and
acquiring the service from the server of the service provider.

6. The service acquisition method of claim 5, further comprising:
receiving authorization assertion information from a first identity provision server;
receiving attribute assertion information from a second identity provision server; and
generating the aggregated attributes by aggregating a first attribute of the authorization assertion information and a second attribute of the attribute assertion information.

7. The service acquisition method of claim 6, wherein the first identity provision server and the second identity provision server are connected to a federated identity environment.

8. The service acquisition method of claim 6, wherein a domain of the first identity provision server and a domain of the second identity provision server are different from each other.

9. The service acquisition method of claim 6, wherein:
the authorization assertion information is transmitted from the first identity provision server to the server of the service provider through a web browser executed in the user terminal; and
the authentication information is transmitted to the server of the service provider through the web browser.

10. The service acquisition method of claim 5, wherein whether it is permissible for the user terminal to access the service is determined based on aggregated attributes.

11. The service acquisition method of claim 6, wherein the attribute assertion information represents an attribute of the user that is required in addition to the authorization assertion information in order to determine whether the access to the service is permissible.

12. The service acquisition method of claim 6, wherein the authorization assertion information represents a part of multiple attributes of the user that are required in order to determine whether the access to the service is permissible.

13. The service acquisition method of claim 6, further comprising,
recognizing that the authorization assertion information is not enough to satisfy requirements for providing the service, based on the authorization assertion information.

14. The service acquisition method of claim 6, wherein if the requirements for providing the service require another attribute of the user other than a first attribute that is represented by the authorization assertion information, the requirements for providing the service are not satisfied.

15. The service acquisition method of claim 6, further comprising,
transmitting the request for authentication to the first identity provision server; and
transmitting the request for the attribute assertion information to the second identity provision server.

16. A service provision method performed by an identity provision server, the method comprising:
receiving a request for attribute assertion information from a user terminal;
generating the attribute assertion information; and
transmitting the request for the attribute assertion information to the user terminal,
wherein the attribute assertion information represents an attribute of a user that is required, in addition to authorization assertion information provided by an additional identity provision server, in order to determine whether it is permissible for the user terminal to access service.

17. The service provision method of claim 16, wherein the identity provision server and the additional identity provision server are connected to a federated identity environment.

18. The service provision method of claim 16, wherein a domain of the identity provision server and a domain of the additional identity provision server are different from each other.

19. The service provision method of claim 16, wherein in providing the attribute assertion information, the identity provision server does not request an additional authentication process from the user terminal by acquiring information related to authentication of the user through the federated identity environment.

20. The service provision method of claim 16, wherein the attribute assertion information is requested when a server of a service provider that provides the service recognizes that the authorization assertion information is not enough to satisfy requirements for providing the service.
